(19) United States
(12) Patent Application Publication
(10) Pub. No.: US 2024/0335027 A1
(43) Pub. Date: Oct. 10, 2024

(54) APPLICATOR AND MANUFACTURING METHOD THEREOF

(71) Applicant: SHYA HSIN PACKAGING INDUSTRY (CHINA) CO., LTD., Kunshan (CN)

(72) Inventor: Haiying YANG, Kunshan (CN)

(73) Assignee: SHYA HSIN PACKAGING INDUSTRY (CHINA) CO., LTD., Kunshan (CN)

(21) Appl. No.: 18/399,790

(22) Filed: Dec. 29, 2023

(30) Foreign Application Priority Data
Apr. 6, 2023 (CN) 202310359732.9

(51) Int. Cl. A46B 9/02; A46B 9/06

(52) U.S. Cl. CPC A46B 9/021; A46B 9/06

(57) ABSTRACT

An applicator and a manufacturing method thereof are provided. The applicator includes a first application assembly and a second application assembly. The first application assembly includes a first rod piece and a first bristle fixedly provided on the first rod piece. The second application assembly includes a second rod piece and a second bristle fixedly provided on the second rod piece. The second rod piece is sleeved on the first rod piece along an axial direction of the first application assembly. The first rod piece is welded with the second rod piece together by fusion. In the applicator, the first application assembly and the second application assembly are provided. The first bristle is provided on the first application assembly, while the second bristle is provided on the second application assembly. Therefore, the applicator can meet different makeup requirements, lower a makeup cost, and simplify a makeup process.

### CROSS REFERENCE TO THE RELATED APPLICATIONS

This application is based upon and claims priority to Chinese Patent Application No. 202310359732.9, filed on Apr. 6, 2023, the entire contents of which are incorporated herein by reference.

### TECHNICAL FIELD

The present application relates to a makeup tool, and in particular to an applicator and a manufacturing method thereof.

### BACKGROUND

Common applicators like eyelash brushes or eyebrow brushes usually use single-material bristles, such as plastic bristles or steel bristles. These applicators can only meet single makeup requirements when used. Thus, during makeup, a user needs to use different types of applicators to complete an entire makeup process. This is not convenient and causes a high cost of makeup.

### SUMMARY

The present application provides an applicator to overcome the above defects. A first application assembly and a second application assembly are provided. A first bristle is provided on the first application assembly, while a second bristle is provided on the second application assembly. Therefore, the applicator can meet different makeup requirements, lower a makeup cost, and simplify a makeup process.

To solve the technical problems, the present application employs the following technical solutions.

An applicator includes a first application assembly and a second application assembly, where the first application assembly includes a first rod piece and a first bristle fixedly provided on the first rod piece; the second application assembly includes a second rod piece and a second bristle fixedly provided on the second rod piece; the second rod piece is sleeved on the first rod piece along an axial direction of the first application assembly; and the first rod piece is welded with the second rod piece by fusion.

Optionally, a groove is formed in the first rod piece along the axial direction, and the second rod piece is provided in the groove.

Optionally, a fixed member is provided in the groove on at least one side of the first rod piece; and

the first rod piece is welded with the second rod piece by fusion, and specifically the fixed member is welded with the second rod piece by fusion.

Optionally, the fixed member is a solid structure; the second rod piece comes in contact with an outer surface of the fixed member; and the outer surface of the fixed member is protruded from the second rod piece along a radial direction; or a through hole is formed in the fixed member, and the second rod piece is inserted into the through hole.

Optionally, a first surface and a second surface opposite to each other are arranged on the first rod piece; the first bristle is provided on the first surface and the second surface; a circle of grooves are formed in the first rod piece between the first surface and the second surface; and the first bristle on the first surface is different from the first bristle on the second surface in target attribute, where the target attribute includes at least one of a density, a length, a diameter and a hardness.

Optionally, the first rod piece, the first bristle and the fixed member are an integrally formed piece made of a plastic material; the second rod piece is made of a metal material; and the second bristle is made of a nylon material or a polybutylene terephthalate (PBT) material.

Optionally, the second rod piece includes a first rod segment, a second rod segment, and a connecting segment; two ends of the connecting segment are respectively fixedly connected to a first end of the first rod segment and a first end of the second rod segment; and each of a second end of the first rod segment and a second end of the second rod segment is a free end.

The present application further provides a manufacturing method of an applicator, which is used for manufacturing the applicator, and includes:
a mounting step: sleeving the second rod piece of the second application assembly on the first rod piece along the axial direction of the first application assembly, where the first application assembly includes the first rod piece;
a power-on step: powering on the second rod piece, such that the fixed member in contact with the second rod piece is fused, where the fixed member is provided on the first rod piece;
a welding step: powering off the second rod piece, such that the fixed member is cooled and welded with the second rod piece together; and
an assembly step: assembling the welded first rod piece to a brush rod.

Optionally, the mounting step includes:
taking out a strip-shaped second rod piece, where the second bristle is provided at a first side and a second side of the second rod piece, and the second rod piece is made of a metal material;
cutting off the second bristle at the first side along a root of the second bristle, and retaining the root of the second bristle connected to the second rod piece;
bending the second rod piece into a U-shaped structure, where the second bristle at the second side is located at an outer side of the second rod piece;
performing injection molding to obtain the integrally formed plastic first application assembly, where the groove is formed in the first rod piece along the axial direction, and the solid fixed member is provided in the groove; and
sleeving the bent second rod piece on the first rod piece, and placing the second rod piece in the groove of the first rod piece.

Optionally, the power-on step includes:
clamping the second rod piece by a fixture, and attaching the first rod segment and the second rod segment to the fixed member, where the second rod piece includes the first rod segment and the second rod segment; and
respectively connecting two electrodes E of different polarities to the first rod segment and the second rod segment, such that the second rod piece is powered on for heating, and the heated second rod piece allows the fixed member to be fused.

The present application has the following beneficial effects:

1) The applicator includes the first application assembly and the second application assembly. The first application assembly includes the first rod piece and the first bristle. The second application assembly includes the second rod piece and the second bristle. The groove is formed in the first rod piece. The fixed member is provided in the groove. The fixed member is welded with the second rod piece together by fusion, such that the first application assembly and the second application assembly are combined together firmly. After the first application assembly and the second application assembly are fixed to the brush rod, the second application assembly does not fall from the brush rod individually. This prolongs a service life of the applicator. The fixed member is welded with the second application assembly by fusion. This does not damage structures of other portions of the second application assembly, makes a fusion process less difficult, and is suitable for manufacturing various applicators.

2) The first bristle is provided on the first rod piece, while the second bristle is provided on the second rod piece. The first bristle and the second bristle can be made of different materials, or the first bristle or the second bristle in a different region has a different length and a different density. This meets requirements of different people and different makeup stages. Therefore, the applicator provides various makeup effects, lowers a makeup cost, and simplifies a makeup process.

### BRIEF DESCRIPTION OF THE DRAWINGS

FIG. 1 is a front view of an applicator according to the present application;

FIG. 2 is a left view of an applicator according to the present application;

FIG. 3 is a right view of an applicator according to the present application;

FIG. 4 is a bottom view of an applicator according to the present application;

FIG. 5 is a partially sectional view of an applicator according to the present application;

FIG. 6 is an enlarged view of A in FIG. 3;

FIG. 7 is an enlarged view of B in FIG. 5;

FIG. 8 is a schematic structural view of a first application assembly according to the present application;

FIG. 9 is a front view of a first application assembly according to the present application;

FIG. 10 is a left view of a first application assembly according to the present application;

FIG. 11 is a bottom view of a first application assembly according to the present application;

FIG. 12 is a front view of a second application assembly according to the present application;

FIG. 13 is a bottom view of a second application assembly according to the present application;

FIG. 14 briefly illustrates a manufacturing process of a second application assembly according to the present application;

FIG. 15 is a schematic power-on view of an applicator according to the present application;

FIG. 16 is a schematic view of an applicator before welding according to the present application; and

FIG. 17 is a schematic view of an applicator after welding according to the present application.

In the figures: 10—first application assembly, 11—first rod piece, 12—first bristle, 13—first surface, 14—second surface, 15—fixed member, 16—groove, 20—second application assembly, 21—second rod piece, 22—second bristle, 23—first rod segment, 24—second rod segment, and 25—connecting segment.

### DETAILED DESCRIPTION OF THE EMBODIMENTS

The technical solutions in the embodiments of the present application are clearly and completely described below with reference to the embodiments of the present application. Apparently, the described embodiments are merely some rather than all of the embodiments of the present application. All other embodiments obtained by a person of ordinary skill in the art based on the embodiments of the present application without creative efforts shall fall within the protection scope of the present application.

It should be noted that the terms “first”, “second”, and so on in the description and claims of this application and in the above accompanying drawings are intended to distinguish similar objects but do not necessarily indicate a specific order or sequence. It should be understood that the objects used in such a way may be exchanged under proper conditions to make it possible to implement the described implementations of this application in sequences except those illustrated or described herein. Moreover, the terms “include”, “have” and their variants mean to cover a non-exclusive inclusion. For example, a process, method, system, product or device that includes a list of steps or units is not necessarily limited to those steps or units which are clearly listed. Instead, they may include other steps or units which are not expressly listed or inherent to such a process, method, product, or device.

For ease of description, spatially relative terms, such as “above”, “on the upper side of”, “on the upper surface of” and “on”, can be used to describe the spatial positional relationship between components or features shown in the figure. It should be understood that the spatially relative terms are intended to encompass different orientations of the components in use or operation in addition to those shown in the figure. For example, if a component in the figure is inverted, it is described as a component “above other component or structure” or “on other component or structure”. Therefore, the component will be positioned as “below other component or structure” or “under other component or structure”. Therefore, the exemplary term “above” may include both orientations “above” and “below”. The component may also be positioned in other different ways (rotated by 90 degrees or in other orientations), but the relative description of the space should be explained accordingly.

### Embodiment

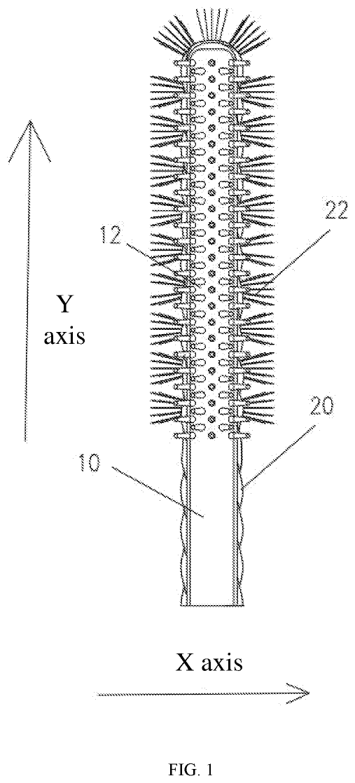

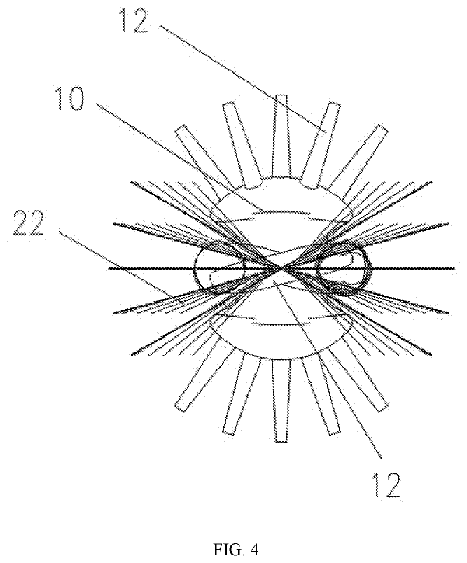

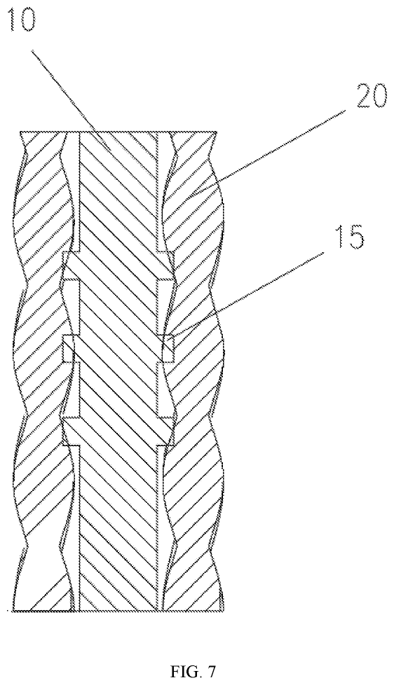

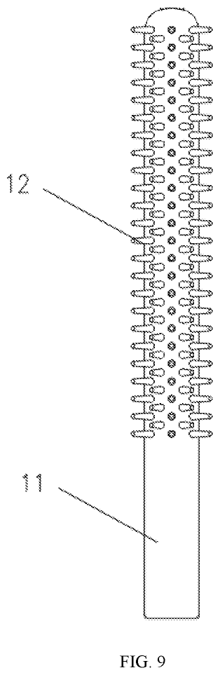

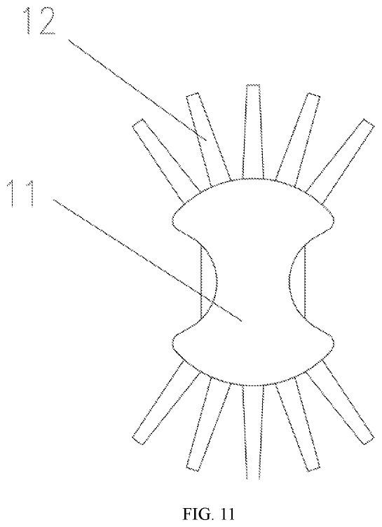

As shown in FIGS. 1-13, an applicator includes first application assembly 10 and second application assembly 20. The first application assembly 10 includes first rod piece 11 and first bristle 12 fixedly provided on the first rod piece 11. The second application assembly 20 includes second rod piece 21 and second bristle 22 fixedly provided on the second rod piece 21. The second rod piece 21 is sleeved on the first rod piece 11 along an axial direction of the first application assembly 10. The first rod piece 11 is welded with the second rod piece 21 by fusion. As shown in FIG. 1, an X-axis direction is defined as a radial direction of the first application assembly 10, and a Y-axis direction is defined as the axial direction of the first application assembly 10. The second rod piece 21 is sleeved on the first rod piece 11 along the Y-axis direction. Since the second rod piece 21 is welded with the first rod piece 11 by fusion, the first application assembly 10 and the second application assembly 20 are combined firmly. Thus, a falling risk of the second application assembly 20 from the axial direction of the first application assembly 10 is effectively reduced. In the present application, the applicator composed of the first application assembly 10 and the second application assembly 20 is provided with the first bristle 12 and the second bristle 22. The first bristle 12 is different from the second bristle 22 in target attribute. The target attribute includes at least one of a density, a length, a diameter and a hardness. For scenes with different makeup requirements, this reduces a number of makeup applicators to be used, lowers a makeup cost, and simplifies a makeup process.

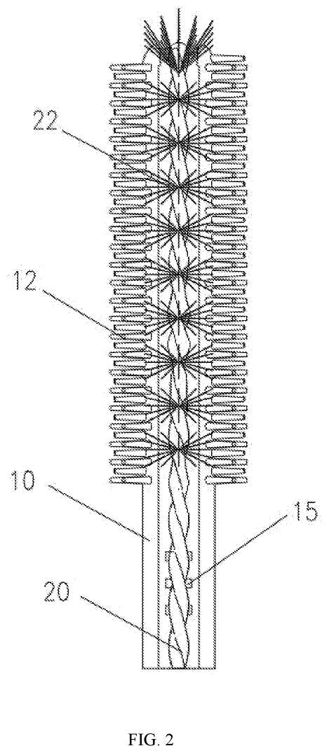

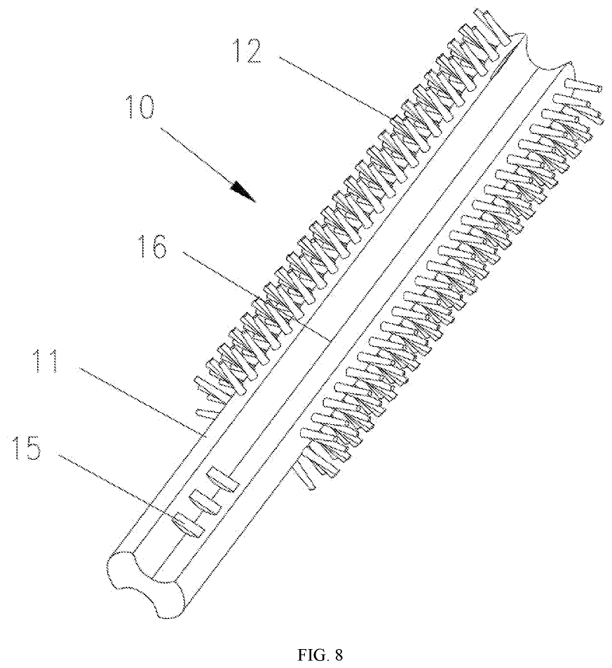

As shown in FIG. 2 and FIG. 8, groove 16 is formed in the first rod piece 11 along the axial direction. The second rod piece 21 is provided in the groove 16. The first rod piece 11 is an elongated structure. A circle of grooves 16 are formed along the axial direction of the first rod piece 11. Optionally, the groove 16 is a U-shaped structure. The second rod piece 21 is also a U-shaped structure. The second rod piece 21 is provided in the groove 16, such that the first application assembly 10 and the second application assembly 20 cooperate more closely. The whole applicator is structurally compact and aesthetically pleasing.

As shown in FIGS. 8-10, fixed member 15 is provided in the groove 16 on at least one side of the first rod piece 11.

The first rod piece 11 is welded with the second rod piece 21 by fusion, which includes: the fixed member 15 is welded with the second rod piece 21 by fusion. The fixed member 15 is provided in the groove 16 in the at least one side of the first rod piece 11, which includes three solutions. In a first solution, as shown in FIG. 8, the fixed member is provided in the groove 16 at a first side of the first rod piece 11. In a second solution, the fixed member is provided in the groove 16 at a second side of the first rod piece 11. In a third solution, the fixed member 15 is provided in the groove 16 at each of two sides of the first rod piece 11. Optionally, the fixed member 15 is provided in the groove 16 at each of two sides of the first rod piece 11. In this way, the fixed member 15 at each of the two sides of the first rod piece 11 is welded with the second rod piece 21, such that the first rod piece and the second rod piece are combined more firmly. The second rod piece 21 is made of a metal material. The fixed member 15 is made of a plastic material. Since the second rod piece 21 is a metal product in welding, the second rod piece 21 can be powered on for heating. The high-temperature second rod piece 21 fuses the plastic fixed member in contact with the second rod piece 21. The cooled and solidified fixed member 15 covers the second rod piece 21, such that the fixed member 15 is welded with the second rod piece 21 together.

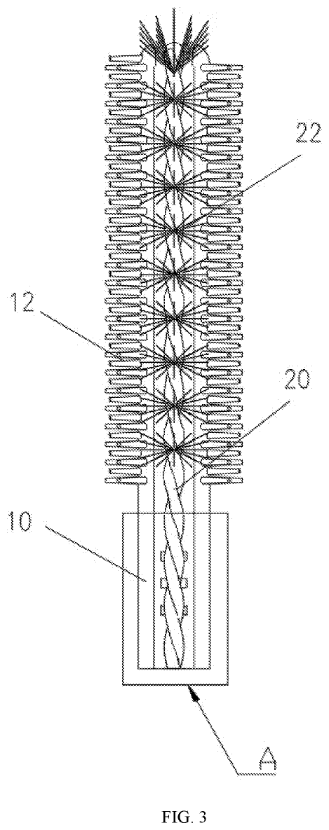

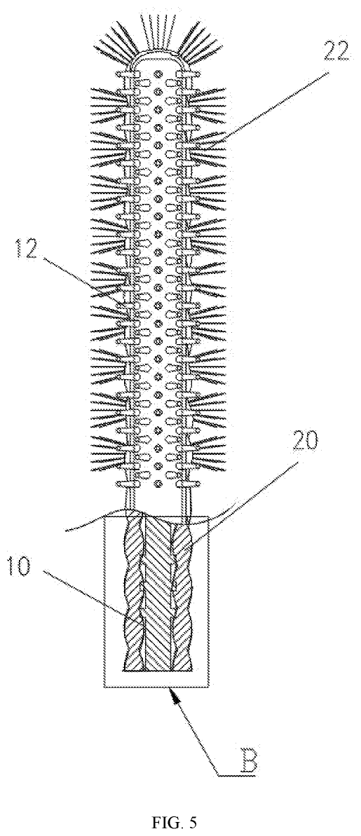

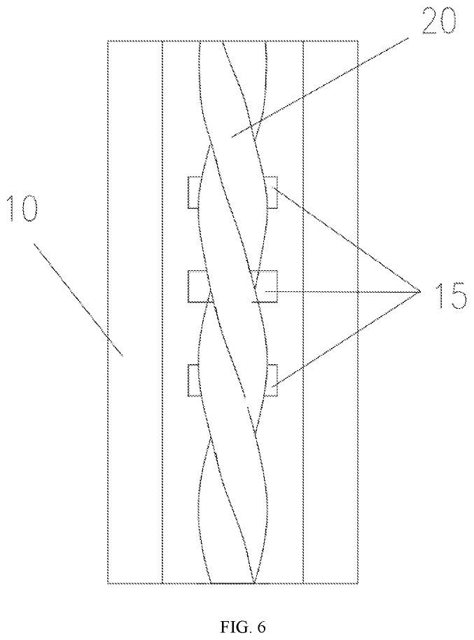

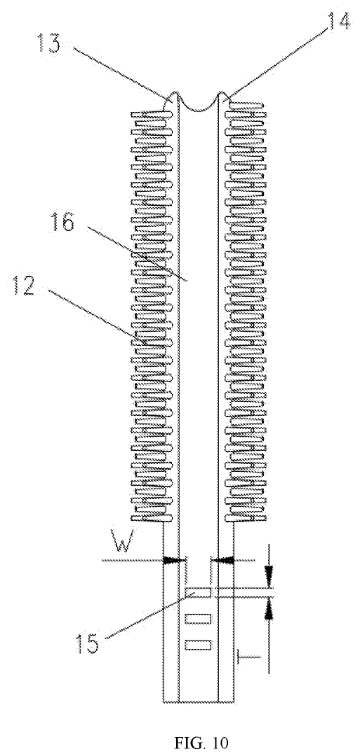

As shown in FIG. 8, the fixed member 15 is a solid structure. The second rod piece 21 comes in contact with an outer surface of the fixed member 15. The outer surface of the fixed member 15 is protruded from the second rod piece 21 along the radial direction. The solid fixed member 15 is provided in the groove 16. There are no limits made on a number of the fixed members 15. Optionally, there are 2-6 fixed members 15. FIG. 5 shows three fixed members 15. In a possible implementation in which the outer surface of the fixed member is protruded from the second rod piece 21 along the radial direction, as shown in FIG. 3 and FIG. 6, a width of the outer surface of the fixed member is greater than a maximum diameter of a position at the contacting second rod piece. This can ensure a large contact area between the fixed member and the second rod piece. Or a through hole is formed in the fixed member 15. The second rod piece 21 is inserted into the through hole. In this way, after the second rod piece 21 is welded with the fixed member 15 by fusion, a circumference of the second rod piece 21 is covered by the fixed member. This further improves a combination strength between the second rod piece and the fixed member. As shown in FIG. 10, the fixed member 15 has a thickness T of 0.5-1.5 mm, and the fixed member 15 has a width W of 1-3 mm. By defining the fixed member 15 within the above range, the contact area between the fixed member and the second rod piece can meet welding requirements.

As shown in FIGS. 8-11, first surface 13 and second surface 14 opposite to each other are arranged on the first rod piece 11. The first bristle 12 is provided on the first surface 13 and the second surface 14. A circle of grooves 16 are formed in the first rod piece 11 between the first surface 13 and the second surface 14. The first bristle 12 on the first surface 13 is different from the first bristle 12 on the second surface 14 in target attribute. The target attribute includes at least one of a density, a length, a diameter and a hardness. For example, the denser and shorter first bristles 12 are provided on the first surface 13, while the sparser and longer first bristles 12 are provided on the second surface 14. This meets requirements of different people and different makeup stages, and enriches a using function of the applicator. Optionally, a root of the first bristle 12 is fixedly connected to the first rod piece 11. A head of the first bristle 12 extends toward a direction away from the first rod piece 11 and the head of the first bristle 12 is a free end. A diameter of the root of the first bristle 12 is greater than a diameter of the head of the first bristle 12.

The first rod piece 11, the first bristle 12 and the fixed member 15 are an integrally formed piece made of a plastic material. The second rod piece 21 is made of a metal material. The second bristle 22 is made of a nylon material or a PBT material. Since the second rod piece 21 is the metal product, the second rod piece 21 can be powered on for heating, thereby fusing the plastic fixed member contacting the second rod piece 21. After cooled, the fixed member is solidified to combine with the second rod piece. Optionally, the second bristle 22 is made of the nylon material. In the embodiment, the first application assembly 10 is the integrally formed plastic piece. The second rod piece 21 is made of the metal material, and the second bristle 22 is made of the nylon material. When the applicator is used, a layer of mascara is applied to the plastic bristle so as to cover each eyelash or eyebrow. The nylon bristle is then used to brush eyelashes at a corner of eyes. The applicator makes eyelashes or eyebrows simple and bright. The nylon bristle can fully contact the eyelashes for a soft texture, such that a better makeup effect is achieved. When the applicator provided by the present application is used, in case of an unsatisfactory shape of the eyelashes or the eyebrows, the plastic bristle can be used to redraw another shape quickly. The nylon bristle is then used for fine trimming. Therefore, the applicator has a desirable cosmetic effect, a high efficiency and a wider application scope, and can meet different makeup requirements.

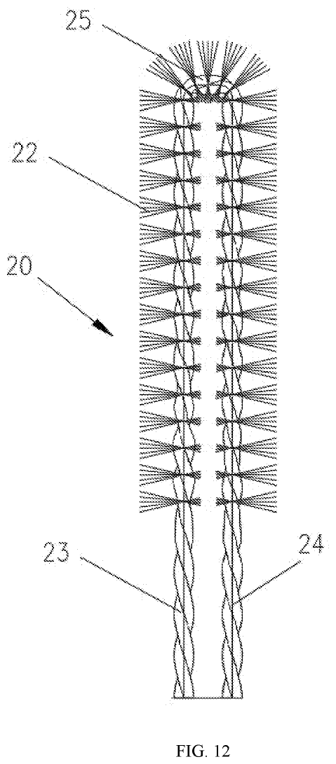

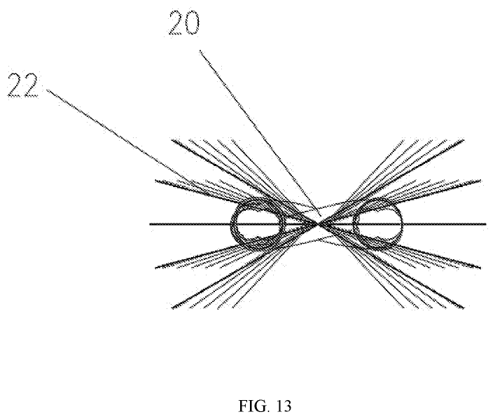

As shown in FIGS. 12-13, the second rod piece 21 includes first rod segment 23, second rod segment 24, and connecting segment 25. Two ends of the connecting segment 25 are respectively fixedly connected to a first end of the first rod segment 23 and a first end of the second rod segment 24. Each of a second end of the first rod segment 23 and a second end of the second rod segment 24 is a free end. The first rod segment 23 and the second rod segment 24 are located at a same side of the connecting segment 25. The second bristle 22 is provided on the connecting segment 25. The second bristle 22 is provided on the first rod segment 23 and the second rod segment 24. Optionally, a portion of each of the first rod segment 23 and the second rod segment 24 close to the connecting segment 25 is provided with the second bristle 22. As shown in FIG. 12, the whole second rod piece 21 is a U-shaped structure.

The applicator further includes a brush rod. The first rod piece 11 is inserted into the brush rod. The first rod piece 11 is fixedly connected to the brush rod. A weld between the first rod piece 11 and the second rod piece 21 is located in the brush rod. The first rod piece 11 and the brush rod may be fixedly connected together by dotting, clamping, gluing, etc. Optionally, the first rod piece 11 and the brush rod are made of a plastic material, and are fixed by the dotting. The first rod piece 11 and the second rod piece 21 are welded, with the weld located in the brush rod. The first rod piece and the second rod piece are combined more firmly to a lower a risk of separation between the first rod piece and the second rod piece. After the first rod piece and the second rod piece are assembled to the brush rod, the second rod piece does not fall from the brush rod individually. This prolongs a service life of the applicator.

A manufacturing method of an applicator is used for manufacturing the applicator, and includes the following steps:

A mounting step: The second rod piece 21 of the second application assembly 20 is sleeved on the first rod piece 11 along the axial direction of the first application assembly 10. The first application assembly 10 includes the first rod piece 11.

A power-on step: The second rod piece 21 is powered on, such that the fixed member 15 in contact with the second rod piece 21 is fused. The fixed member 15 is provided on the first rod piece 11.

A welding step: The second rod piece 21 is powered off, such that the fixed member 15 is cooled and welded with the second rod piece 21 together.

An assembly step: The welded first rod piece 11 is welded to a brush rod. The first rod piece and the brush rod are fixedly connected together by the dotting, the clamping or the gluing. The weld between the first rod piece 11 and the second rod piece 21 is located in the brush rod.

The mounting step includes:

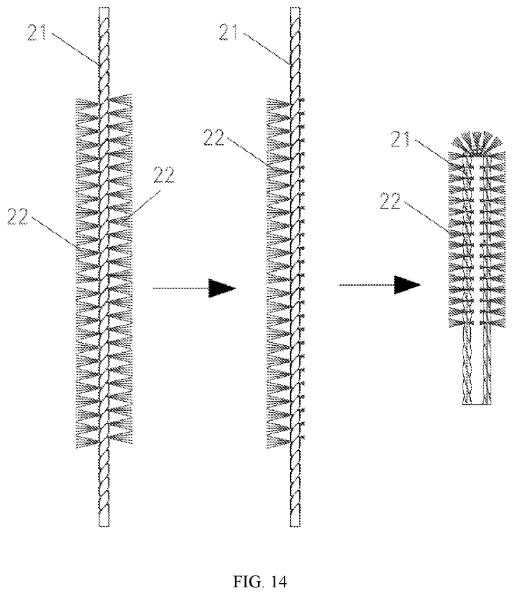

As shown in FIG. 14, a strip-shaped second rod piece 21 is taken out. The second bristle 22 is provided at a first side and a second side of the second rod piece 21. The second rod piece 21 is made of a metal material. In a possible implementation in which the second bristle 22 is provided at a first side and a second side of the second rod piece 21, the second bristle 22 at the first side is provided within a range of 0° to 180° in a circumferential direction of the second brush rod 21, and the second bristle 22 at the second side is provided within a range of 180° to 360° in the circumferential direction of the second brush rod 21. That is, the second bristle 22 at the first side and the second side covers the whole circumferential direction of the second brush rod 21.

The second bristle 22 at the first side is cut off along a root of the second bristle 22. The root of the second bristle 22 connected to the second rod piece 21, and the second bristle 22 at the second side are retained.

The second rod piece 21 is bent into a U-shaped structure. The second bristle 22 at the second side is located at an outer side of the second rod piece 21.

Injection molding is performed to obtain the integrally formed plastic first application assembly 10. The groove 16 is formed in the first rod piece 11 along the axial direction. The solid fixed member 15 is provided in the groove 16.

The bent second rod piece 21 is sleeved on the first rod piece 11. The second rod piece 21 is placed in the groove 16 of the first rod piece 11.

The power-on step includes:

The second rod piece 21 is clamped by a fixture. The first rod segment 23 and the second rod segment 24 are attached to the fixed member 15. The second rod piece 21 includes the first rod segment 23 and the second rod segment 24.

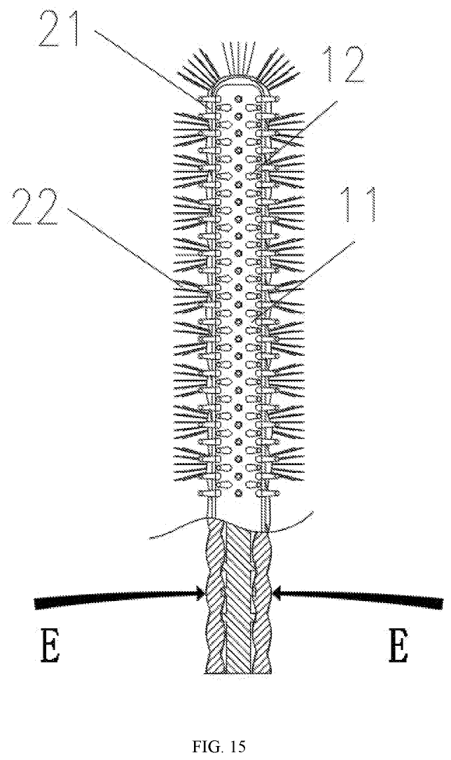

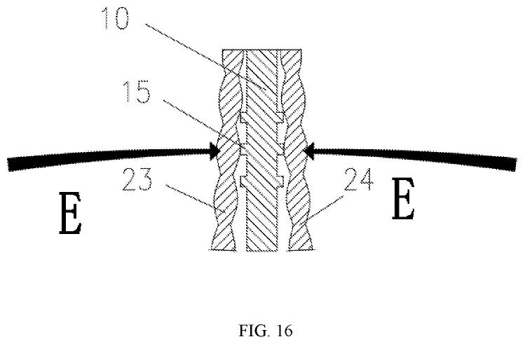

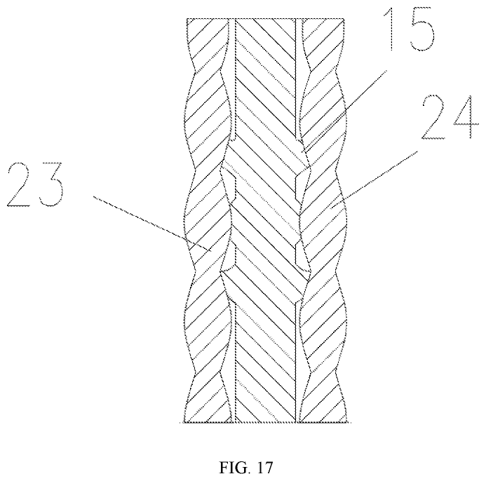

As shown in FIG. 15, two electrodes E of different polarities are respectively connected to the first rod segment 23 and the second rod segment 24, such that the second rod piece 21 is powered on for heating, and the heated second rod piece 21 allows the fixed member 15 to be fused. FIG. 16 illustrates the fixed member 15, the first rod segment 23 and the second rod segment 24 before heating. As shown in FIG. 17, after the second rod piece is powered off, the fixed member 15 is cooled, solidified and welded with the second rod piece 21 together.

In the manufacturing method, the second rod piece 21 is made of the metal material, and the fixed member 15 of the first rod piece 11 is made of the plastic material. By connecting two electrodes of different polarities to the second rod piece 21, the second rod piece 21 is powered on for heating. The heated second rod piece 21 fuses the contacting fixed member 15. After the second rod piece is powered off, the fixed member 15 is solidified again and welded with the second rod piece 21 together. Therefore, the first application assembly 10 and the second application assembly 20 are combined firmly to effectively reduce a falling risk of the second application assembly 20 from the first application assembly 10. In the present application, the first application assembly 10 is provided with the fixed member, and welded with the second application assembly by fusion through the fixed member. This does not damage structures of other portions of the second application assembly, makes a fusion process less difficult, and is suitable for manufacturing various applicators.

It should be noted that those of ordinary skill in the art can further make variations and improvements without departing from the conception of the present application. These variations and improvements all fall within the protection scope of the present application. Therefore, the protection scope of this application shall be subject to the appended claims.

What is claimed is:

1. An applicator, comprising a first application assembly and a second application assembly, wherein the first application assembly comprises a first rod piece and a first bristle fixedly provided on the first rod piece; the second application assembly comprises a second rod piece and a second bristle fixedly provided on the second rod piece; the second rod piece is sleeved on the first rod piece along an axial direction of the first application assembly; and the first rod piece is welded with the second rod piece by fusion.

2. The applicator according to claim 1, wherein a groove is formed in the first rod piece along the axial direction, and the second rod piece is provided in the groove.

3. The applicator according to claim 2, wherein a fixed member is provided in the groove on at least one side of the first rod piece; and
the first rod piece is welded with the second rod piece by fusion, wherein the fixed member is welded with the second rod piece by fusion.

4. The applicator according to claim 3, wherein the fixed member is a solid structure; the second rod piece comes in contact with an outer surface of the fixed member; and the outer surface of the fixed member is protruded from the second rod piece along a radial direction; or a through hole is formed in the fixed member, and the second rod piece is inserted into the through hole.

5. The applicator according to claim 2, wherein a first surface and a second surface opposite to each other are arranged on the first rod piece; the first bristle is provided on the first surface and the second surface; a circle of grooves are formed in the first rod piece between the first surface and the second surface; and the first bristle on the first surface is different from the first bristle on the second surface in target attribute, wherein the target attribute comprises at least one of a density, a length, a diameter and a hardness.

6. The applicator according to claim 3, wherein the first rod piece, the first bristle and the fixed member are an integrally formed piece made of a plastic material; the second rod piece is made of a metal material; and the second bristle is made of a nylon material or a polybutylene terephthalate (PBT) material.

7. The applicator according to claim 1, wherein the second rod piece comprises a first rod segment, a second rod segment, and a connecting segment; two ends of the connecting segment are respectively fixedly connected to a first end of the first rod segment and a first end of the second rod segment; and each of a second end of the first rod segment and a second end of the second rod segment is a free end.

8. A manufacturing method of an applicator, used for manufacturing the applicator according to claim 1, and comprising:
a mounting step: sleeving the second rod piece of the second application assembly on the first rod piece along the axial direction of the first application assembly, wherein the first application assembly comprises the first rod piece;
a power-on step: powering on the second rod piece, such that the fixed member in contact with the second rod piece is fused, wherein the fixed member is provided on the first rod piece;
a welding step: powering off the second rod piece, such that the fixed member is cooled and welded with the second rod piece together; and
an assembly step: assembling the welded first rod piece to a brush rod.

9. The manufacturing method of the applicator according to claim 8, wherein the mounting step comprises:
taking out a strip-shaped second rod piece, wherein the second bristle is provided at a first side and a second side of the second rod piece, and the second rod piece is made of a metal material;
cutting off the second bristle at the first side along a root of the second bristle, and retaining the root of the second bristle connected to the second rod piece;
bending the second rod piece into a U-shaped structure, wherein the second bristle at the second side is located at an outer side of the second rod piece;
performing injection molding to obtain the integrally formed plastic first application assembly, wherein the groove is formed in the first rod piece along the axial direction, and the solid fixed member is provided in the groove; and
sleeving the bent second rod piece on the first rod piece, and placing the second rod piece in the groove of the first rod piece.

10. The manufacturing method of the applicator according to claim 9, wherein
the power-on step comprises:
clamping the second rod piece by a fixture, and attaching a first rod segment and a second rod segment to the fixed member, wherein the second rod piece comprises the first rod segment and the second rod segment; and
respectively connecting two electrodes E of different polarities to the first rod segment and the second rod segment, such that the second rod piece is powered on for heating, and the heated second rod piece allows the fixed member to be fused.

11. The manufacturing method of the applicator according to claim 8, wherein in the applicator, a groove is formed in the first rod piece along the axial direction, and the second rod piece is provided in the groove.

12. The manufacturing method of the applicator according to claim 11, wherein in the applicator, a fixed member is provided in the groove on at least one side of the first rod piece; and
the first rod piece is welded with the second rod piece by fusion, wherein the fixed member is welded with the second rod piece by fusion.

13. The manufacturing method of the applicator according to claim 12, wherein in the applicator, the fixed member is a solid structure; the second rod piece comes in contact with an outer surface of the fixed member; and the outer surface of the fixed member is protruded from the second rod piece along a radial direction; or a through hole is formed in the fixed member, and the second rod piece is inserted into the through hole.

14. The manufacturing method of the applicator according to claim 11, wherein in the applicator, a first surface and a second surface opposite to each other are arranged on the first rod piece; the first bristle is provided on the first surface and the second surface; a circle of grooves are formed in the first rod piece between the first surface and the second surface; and the first bristle on the first surface is different from the first bristle on the second surface in target attribute, wherein the target attribute comprises at least one of a density, a length, a diameter and a hardness.

15. The manufacturing method of the applicator according to claim 12, wherein in the applicator, the first rod piece, the first bristle and the fixed member are an integrally formed piece made of a plastic material; the second rod piece is made of a metal material; and the second bristle is made of a nylon material or a polybutylene terephthalate (PBT) material.

16. The manufacturing method of the applicator according to claim 8, wherein in the applicator, the second rod piece comprises a first rod segment, a second rod segment, and a connecting segment; two ends of the connecting segment are respectively fixedly connected to a first end of the first rod segment and a first end of the second rod segment; and each of a second end of the first rod segment and a second end of the second rod segment is a free end.
